(19) United States
(12) Patent Application Publication
(10) Pub. No.: US 2006/0210470 A1
(43) Pub. Date: Sep. 21, 2006

(54) System and method for generating hydrogen

(75) Inventors: Evgeny Shafirovich, West Lafayette, IN (US); Victor E. Diakov, Lafayette, IN (US); Arvind Varma, West Lafayette, IN (US)

Correspondence Address: BRINKS HOFER GILSON & LIONE, P.O. BOX 10395, CHICAGO, IL, 60610, US

(73) Assignee: Purdue Research Foundation

(21) Appl. No.: 11/371,616

(22) Filed: Mar. 9, 2006

Related U.S. Application Data
(60) Provisional application No. 60/663,238, filed on Mar. 18, 2005.

(51) Int. Cl. C01B 3/02; C01B 3/08

(52) U.S. Cl. 423/648.1; 423/657

(57) ABSTRACT

A method of generating hydrogen is disclosed. The method comprises preparing a first mixture of a stabilizer and a gelling agent in water to define a resulting solution. The method further comprises mixing the resulting solution with metallic particles and metal borohydride to define a resulting mixture. The method further comprises igniting the resulting mixture to obtain hydrogen.

### CROSS-REFERENCE TO RELATED APPLICATIONS

This application claims the benefit of U.S. Provisional Application Ser. No. 60/663,238, filed on Mar. 18, 2005, entitled “SYSTEM AND METHOD OF GENERATING HYDROGEN,” the entire contents of which are incorporated herein by reference.

### FIELD OF THE INVENTION

The present invention relates to systems and methods of generating hydrogen.

### BACKGROUND OF THE INVENTION

Combustion of solid mixtures is widely used for gas generation in various applications, e.g., in creating thrust in rocket engines or inflating air bags in case of car collisions. Hydrogen storage is considered a factor in the transition from fossil-fuel to hydrogen-based economy. Generation of hydrogen by combustion is of particular interest for fuel-cell based portable electronics and emergency power sources.

More specifically, hydrogen storage and generation systems are needed for lightweight, robust, cost effective fuel cell power sources. Hydrogen generation by combustion is of interest for portable power supplies to be used, for example, as chargers in various electronic devices. Thus, it is desired to identify systems that generate hydrogen during combustion and exhibit high hydrogen yield.

Moreover, as portable electronic devices, such as mobile phones, notebook computers, and other handheld device are becoming more widespread and power-demanding, fuel cell power sources are needed with higher specific energy (Wh/g) than batteries. In this context, direct methanol fuel cells (DMFC) have been suggested as power sources for small scale applications, but have drawbacks, including low power density, methanol crossover, electrode poisoning and methanol toxicity. Current hydrogen fuel cells do not have any methanol-related problems and provide higher power density and double conversion efficiency as compared to DMFCs. Hydrogen storage, however, is a challenge in the development of hydrogen fuel cell power sources. Compressed gas and reversible metal hydrides cannot provide sufficient hydrogen yield, while use of liquid hydrogen is currently not applicable in portable applications.

Some techniques call for using compounds with high content of hydrogen, released during chemical reaction with water. Many processes seem promising due to their relatively high theoretical hydrogen yield. However, the practical solution strengths are limited and, in turn, decrease maximum hydrogen yield to significantly less than the theoretical hydrogen yield. Further, reaction initiation typically requires introducing a catalyst to the mixture creating difficulty particularly for small scale applications.

Although hydrogen generation by combustion has been studied extensively for chemical laser applications since the 1970's, manufacturers continue to be challenged in avoiding the use of toxic components, poisonous gases to an anode catalyst, and expensive substances. The mixtures are typically based on compounds with high hydrogen content. However, many compounds are not suitable. For example, hydrazine, diborane and their derivatives, such as N₂H₄(BH₃)₂, are not suitable for fuel cell applications because of their extreme toxicity. Some other compositions generate gases, such as CO and NH₃, poisonous for the anode catalyst.

Thus, there is a need to provide a way to generate hydrogen with sufficient hydrogen yield applicable on any suitable system including portable systems in a cost effective manner without requiring catalysts, toxic compounds, or poisonous substances.

### BRIEF SUMMARY OF THE INVENTION

The present invention generally provides examples of generating hydrogen with sufficient hydrogen yield applicable for any suitable system including portable systems in a cost effective matter. Examples of the present invention generate hydrogen in an efficient way that allows for hydrogen storage without requiring catalysts, toxicity, or poisonous or harmful components.

In one example, the present invention provides a method of generating hydrogen. The method comprises preparing a first mixture of a stabilizer and a gelling agent in water to define a resulting gel. The method further comprises mixing the resulting gel with metallic particles and metal borohydride to define a resulting mixture. The method further comprises igniting the resulting mixture to obtain hydrogen.

In another example, the present invention provides a method of generating hydrogen by combustion of a sodium borohydride-metal-water mixture. The method comprises preparing a first mixture of between about 1 and 10 percent weight sodium hydroxide and between about 1 and 10 percent weight polyacrylamide in distilled water to define a resulting gel. The method further comprises mixing the resulting gel with metal borohydride and metallic particles to define the sodium borohydride-metal-water mixture. The method further comprises heating the sodium borohydride-metal-water mixture to produce hydrogen from the sodium borohydride and the water by combustion.

In yet another example of the present invention, the method comprises a method of generating hydrogen. The method comprises mixing a reactant gel with a metallic powder and metal borohydride to define a resulting mixture. In this example, the reactant gel includes a stabilizer and a gelling agent in water. The method further comprises igniting the resulting mixture to produce hydrogen.

In still another example of the present invention, the method comprises preparing a first mixture of a stabilizer in water to define a resulting solution and mixing the resulting solution with metallic particles and metal borohydride to define a resulting mixture. The method further comprises igniting the resulting mixture to obtain hydrogen.

Further objects, features, and advantages of the present invention will become apparent from consideration of the following description and the appended claims when taken in connection with the accompanying drawings.

### BRIEF DESCRIPTION OF THE DRAWINGS

FIG. 1 is a graph of combustion temperature and hydrogen yield as functions of mass ratio of a method for generating hydrogen from borohydride-metal-water mixtures in accordance with one example of the present invention;

FIG. 2 is schematic diagram of an apparatus for a method of generating hydrogen from borohydride-metal-water mixtures in accordance with one example of the present invention;

FIGS. 3a-e are images of reaction wave propagation having a borohydride-aluminum-water mixture;

FIGS. 4a-e are images of reaction wave propagation having a borohydride-magnesium-water mixture;

FIG. 5 is a graph depicting a pressure variation curve during combustion of the borohydride-aluminum-water mixture;

FIG. 6 is a graph depicting a pressure variation curve during combustion of the borohydride-magnesium-water mixture;

FIG. 7 is a graph depicting combustion front velocity curves of the borohydride-metal-water mixtures; and

FIG. 8 is a graph depicting hydrogen yield of the borohydride-metal-water mixtures.

### DETAILED DESCRIPTION OF THE INVENTION

Examples of the present invention generate hydrogen in a relatively efficient manner without including any catalysts or toxic components. In one example, the method comprises using combustion of triple borohydride-metal-water mixtures, wherein relatively high-exothermic reactions between metal and water create conditions for hydrolysis of borohydride. The mixtures ignite and burn in inert atmosphere to produce hydrogen, sodium metaborate and metal oxides—all environmentally benign materials. The mixtures are independent of any catalysts or toxic components.

In one example, the method of generating hydrogen comprises preparing a first mixture of a stabilizer and a gelling agent in water to define a resulting gel. The method further comprises mixing the resulting gel with metallic particles and metal borohydride to define a resulting mixture. Preferably, the metal borohydride is sodium borohydride. The method further comprises igniting the resulting mixture to obtain hydrogen.

In this example, the stabilizer may be any suitable substance including an alkali, e.g., sodium hydroxide (NaOH). The stabilizer is prepared with the gelling agent to reduce or prevent hydrolysis of borohydride at room temperature. Preferably, the stabilizer comprises between about 1 and 10 percent weight sodium hydroxide and more preferably about 2 percent weight sodium hydroxide.

The gelling agent may include any suitable substance, e.g., polyacrylamide. Preferably, the gelling agent may comprise between about 1 and 10 percent weight polyacrylamide and more preferably about 3 percent weight polyacrylamide.

In this example of the present invention, the metallic particles comprise aluminum (Al), magnesium (Mg), or their alloy. Preferably, the aluminum particles comprise nanoscale aluminum particles and more preferably having an average particle size of between about 70 and 100 nanometers. In yet another example, the magnesium particles comprise microscale magnesium particles.

In this example of the present invention, the resulting mixture is the borohydride-metal-water mixture. The combustion of the resulting mixture is performed wherein high-exothermic reactions between metal and water create conditions for the hydrolysis of borohydride. Preferably, this is accomplished by performing the reactions as follows:
NaBH₄+2 H₂O→NaBO₂+4 H₂ (1)
Al+1.5 H₂O→0.5 Al₂O₃+1.5 H₂ (2)
or
NaBH₄+2 H₂O→NaBO₂+4 H₂ (1)
Mg+H₂O→MgO+H₂. (3)

By performing reaction (1) with either reaction (2) or (3) in one combustion process, higher hydrogen yields are reached than by performing reaction (2) or (3) alone and by performing reaction (1) without any catalyst. Moreover, the triple borohydride-metal-water mixtures are absent in producing any harmful compounds of Nitrogen, Chlorine, or Sulfur. The mixtures of sodium borohydride with water and metal (e.g., aluminum or magnesium powder) ignite relatively easily at about room temperature and burn in inert atmosphere, producing hydrogen, sodium metaborate (NaBO₂) and alumina (Al₂O₃) or magnesia (MgO). Such products are environmentally benign materials. As mentioned above, the borohydride-metal-water mixtures include relatively small quantities of the resulting gel, including a gelling agent (e.g., polyacrylamide) and a stabilizer (e.g., NaOH), to prevent hydrolysis of borohydride at room temperature.

In reaction (1), water in this example is both a reactant and an additional source of hydrogen. As a result, borohydrides provide relatively high hydrogen yield making them attractive for applications. As will be shown below, the moderate exothermicity of the metal borohydrides hydrolysis welcomes the presence of either reactions (2) or (3) for the combustion-based hydrogen generation without any catalysts.

One of reactions (2) and (3) may be used in parallel with reaction (1) to generate hydrogen by way of combustion of metals with water. As mentioned above, such metals may include aluminum or magnesium, or their alloys. In each of reactions (2) and (3), water acts as an oxidizer for the metal and as the sole source of hydrogen. The adiabatic combustion temperature of the stoichiometric mixtures, e.g., Al/H₂O and Mg/H₂O, at pressure 1 atmosphere (atm) is about 2900 and 2750 K, respectively, indicating that the heat release is sufficient for self-sustained reaction of reactions (1) and (2) or reactions (1) and (3).

In one example, the use of nanoscale aluminum particles or microscale magnesium particles decreases the ignition temperature of the metal, while the gelling agent inhibits water evaporation during the process. Hence, the borohydride-metal-water mixture ignites easily and reacts in inert atmosphere, producing hydrogen. Alumina and magnesia, produced also in reactions (2) and (3), are environmentally benign materials.

In one example, about 2 percent weight NaOH and 3 percent weight polyacrylamide (M_{w}=5×10⁶) are prepared in preferably distilled water to define a resulting gel. The resulting gel is mixed with NaBH₄ and aluminum powders, preferably nanoscale aluminum particles having an average particle size of about 80 nm. The resulting mixture is then ignited to generate hydrogen.

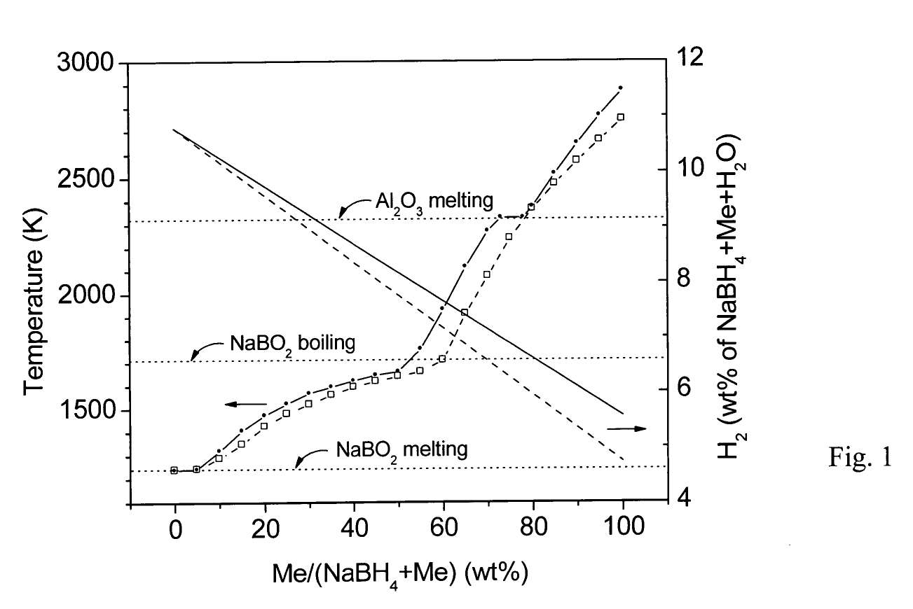

Thermodynamic calculations for NaBH₄/Al/H₂O and NaBH₄/Mg/H₂O systems were performed. This was accomplished by using Thermo™ software version 4.3 (Feb. 20, 1995) manufactured by the Institute of Structural Macrokinetics and Materials Science, Russian Academy of Sciences (Chernogolovka, Russia), Copyright 1993 Dr. A. Shiryaev, E. Petrova. As shown in FIG. 1, adiabatic combustion is depicted with a temperature at 1 atmosphere of pressure and H₂ yield as functions of Me/(NaBH₄+Me) mass ratio. In this example, the Me is aluminum (Al) or magnesium (Mg), and the H₂O fraction was selected to obtain stoichiometric mixtures for reactions (1), and either (2) or (3). Thus, the Me content value 0% in FIG. 1 corresponds to the reaction (1) while the 100% value corresponds to either the reaction (2) or (3). With the Me addition, the combustion temperature increases while the H₂ yield decreases. For both Al and Mg, the temperature curve slope increases upon reaching the boiling point of NaBO₂ (about 1707 K), which occurs at about 50% for Al and about 60% for Mg.

As depicted in FIG. 1, mixtures with Me/(NaBH₄+Me) ratios between about 50% and 80% exhibit high combustion efficiency and also provide relatively high hydrogen yield, e.g., between about 6 and 8 percent weight.

In yet another example, the applicants have found that if the metallic particles comprise nanoscale aluminum particles, then the first mixture may not necessarily comprise a gelling agent. Thus, in this example, first mixture is free of a gelling agent and comprises the stabilizer in water to define a resulting solution. The resulting solution is then mixed with the metallic particles and metal borohydride to define the resulting mixture. The resulting mixture is then ignited to generate hydrogen.

### EXAMPLE

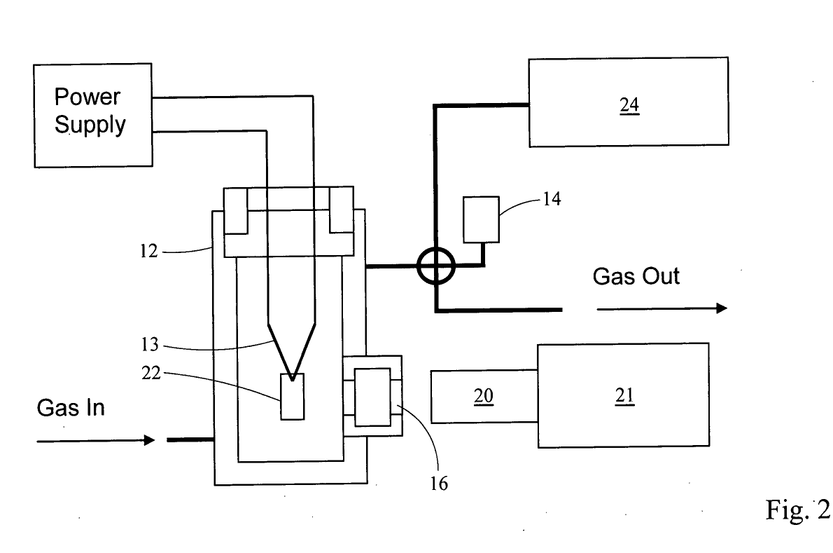

This example provides a method of generating hydrogen. In this example, experiments on combustion of the NaBH₄/Al/H₂O mixtures were conducted. FIG. 2 illustrates a combustion system comprising a 3-L stainless steel chamber 12 equipped with a hot-wire igniter 13, a pressure transducer 14 and windows 16 for reaction monitoring via lens 20 and digital video camera 21. The preparation of mixtures included addition of about 2 wt % NaOH (about 99% pure, Mallinckrodt Chemicals) and about 3 wt % poly(acrylamide-co-acrylic acid) (M_{w}=5×10⁶, Aldrich) in distilled water, and mixing the resulting gel with NaBH₄ (about 96% pure, Mallinckrodt Chemicals) and metal powders. Nanoscale Al powder (average particle size 80 nm, passivated, free metallic aluminum 83%, Nanotechnologies), Al powder (less than about 45 μm, average particle size between about 7 and 15 μm, 99.5% pure, Alfa Aesar,) and Mg powder (less than about 45 μm, 99.8% pure, Alfa Aesar) were tested.

The resulting mixture was placed in a quartz cylinder (height 3 cm, inner diameter 1 cm) represented by reference numeral 22 in FIG. 2 and ignited by a Nichrome coil embedded in the top layer of sample. The experiments were conducted in argon at 1 atm initial pressure. Digital video camera (Vision Research Phantom 5.1) was used for visualization of combustion and measurement of front velocity. The chamber 12 pressure was monitored using the pressure transducer 14 (Transmetrics P052HHD184). The resulting gas composition was analyzed by gas chromatography 24 (Hewlett Packard HP 5890 Series II) at room temperature, after the gas equilibrated with the reaction chamber 12. The condensed combustion products were analyzed by powder XRD (Scintag, X2 Advanced Diffraction System). [

The experiments for various metal/NaBH₄ ratios at stoichiometric water contents show that mixtures with relatively coarser Al powder do not burn while those with Mg and nanoscale Al powders are combustible. This is associated with the desire to ignite metal particles in the combustion front.

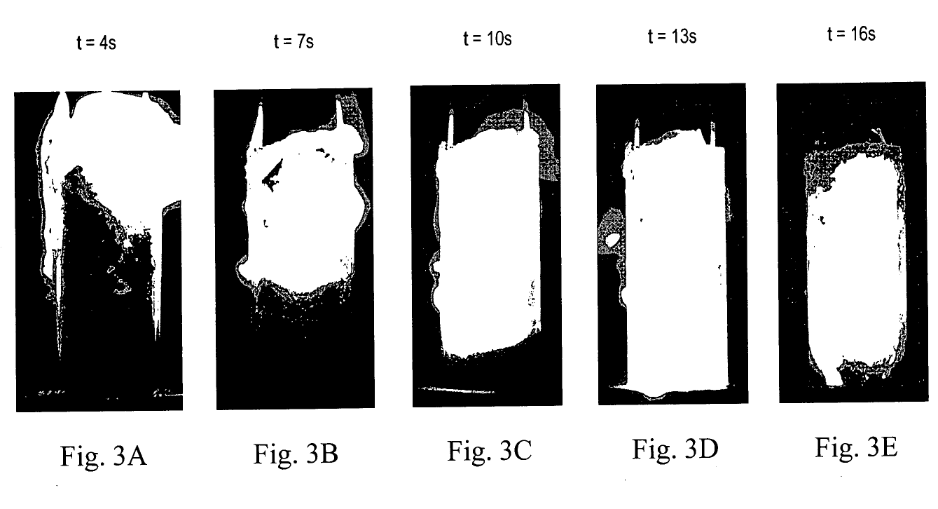

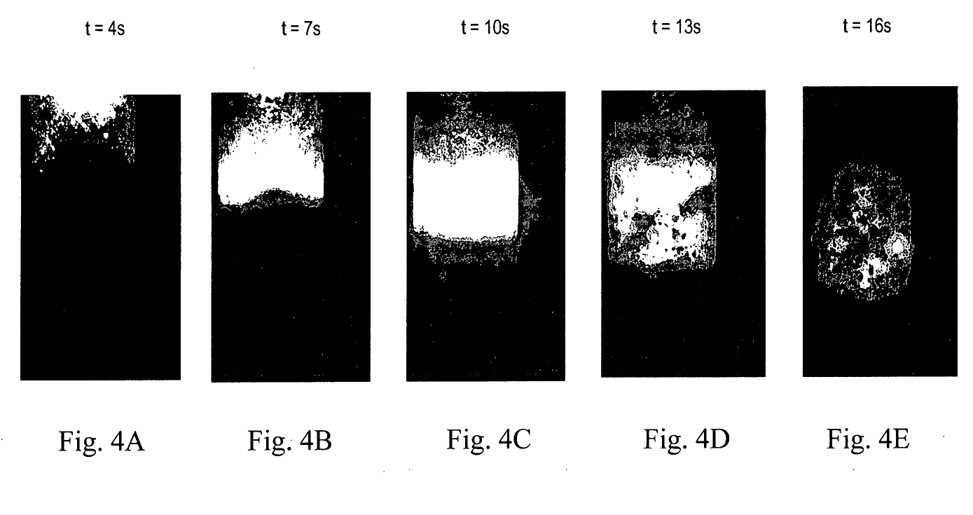

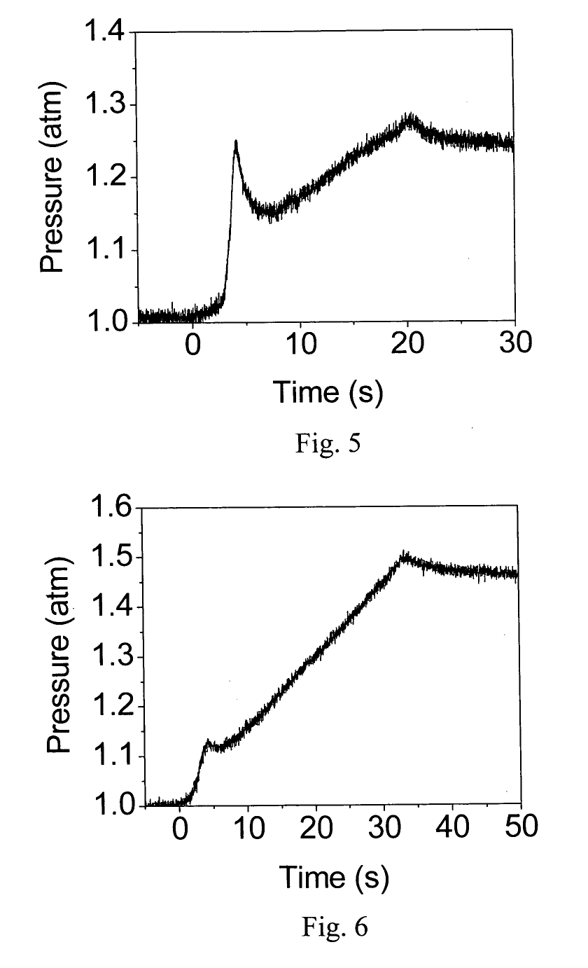

Increasing metal fuel loading significantly stimulates combustion. Specifically, reaction with no metal fuel addition requires permanent heating by the igniter, while metal fuel-rich mixtures burn vigorously as depicted in FIGS. 3a-3e and 4a-4e. The reaction wave propagates uniformly along the sample while the gaseous products flow in the reverse direction through the combustion products towards the open top end of the sample. As shown in FIGS. 5 and 6, in the pressure curves, the initial peak arises due to hot hydrogen released during fast ignition of the top layer (visually a bright flash is observed, see FIGS. 3a-3e, t=4 s), with subsequent fast cooling owing to heat losses.

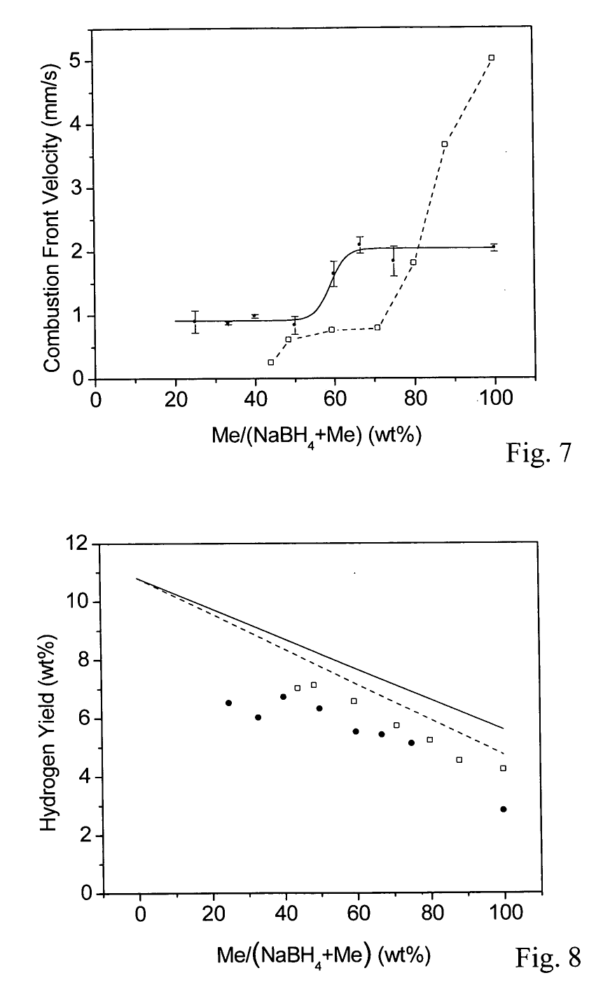

In the second stage of the process, the gradual pressure growth corresponds to hydrogen generation during uniform propagation of the combustion front, while the final decrease is caused by cooling. The dependence of combustion front velocity on the metal fuel content is shown in FIG. 7. As may be seen, the velocity increases significantly when the metal fuel mass fraction reaches about 60 wt % for Al and about 80 wt % for Mg. This compares well with the sharp rise of adiabatic combustion temperature for both Al— and Mg-containing mixtures (see FIG. 1).

Powder XRD analysis of condensed products shows sodium metaborate (NaBO₂), metal oxide (Al₂O₃ or MgO) and, in the case of Al, some amount of unreacted metal. Gas chromatography indicates that the evolved gas is essentially hydrogen (about 99%). It is to be noted that vapors of unreacted water and formed NaBO₂ (likely to be present during combustion) condense readily upon cooling and hence are not present in the gaseous products. FIG. 8 depicts measured hydrogen yield in NaBH₄/Al/H₂O and NaBH₄/Mg/H₂O mixtures in comparison with the theoretical values. The efficiency of hydrogen generation is between about 74 and 77% for the mixtures with Al and between about 88 and 92% for the mixtures with Mg. The lower efficiency for Al is likely caused by the larger oxide content in the passivated Al nanoparticles. The maximum observed H₂ yield is about 7 wt % for both systems.

Furthermore, the triple sodium borohydride/metal/water mixtures with polyacrylamide and NaOH additives are combustible and exhibit higher hydrogen yield than theoretically achievable for either reaction (2) or (3) alone. In these mixtures, the highly exothermic combustion reaction (2) or (3) assists sodium borohydride hydrolysis (1). This eliminates the use of catalyst, one of the challenges for portable fuel cell applications. The proposed mixtures provide self-sustained generation of hydrogen with relatively high hydrogen yield.

While the present invention has been described in terms of preferred embodiments, it will be understood, of course, that the invention is not limited thereto since modifications may be made to those skilled in the art, particularly in light of the foregoing teachings.

1. A method of generating hydrogen, the method comprising:
preparing a first mixture of a stabilizer and a gelling agent in water to define a resulting gel;
mixing the resulting gel with metallic particles and metal borohydride to define a resulting mixture; and
igniting the resulting mixture to obtain hydrogen.

2. The method of claim 1 wherein the stabilizer is a soluble alkali.

3. The method of claim 1 wherein the stabilizer comprises between about 1 and 10 percent weight sodium hydroxide and the gelling agent comprises between about 1 and 10 percent weight polyacrylamide.

4. The method of claim 1 wherein the stabilizer comprises about 2 percent weight sodium hydroxide.

5. The method of claim 1 wherein the gelling agent comprises about 3 percent weight polyacrylamide.

6. The method of claim 1 wherein the stabilizer comprises about 2 percent weight sodium hydroxide and the gelling agent comprises about 3 percent weight polyacrylamide.

7. The method of claim 1 wherein the metal borohydride is sodium borohydride.

8. The method of claim 1 wherein the metallic particles of the resulting mixture comprise at least one of aluminum, magnesium, aluminum-magnesium alloy particles.

9. The method of claim 8 wherein the aluminum particles comprise nanoscale aluminum particles.

10. The method of claim 9 wherein the nanoscale aluminum particles have an average particle size of between about 70 and 100 nanometers.

11. The method of claim 8 wherein the magnesium particles comprise microscale magnesium particles.

12. The method of claim 1 wherein the step of heating comprises reactions as follows:
NaBH₄+2 H₂O→NaBO₂+4 H₂; and
Al+3/2 H₂O→1/2 Al₂O₃+3/2 H₂.

13. The method of claim 1 wherein the step of heating comprises reactions as follows:
NaBH₄+2 H₂O→NaBO₂+4 H₂; and
Mg+H₂O→MgO+H₂.

14. A method of generating hydrogen by combustion of a sodium borohydride-metal-water mixture, the method comprising:
preparing a first mixture of between about 1 and 10 percent weight sodium hydroxide and between about 1 and 10 percent weight polyacrylamide in distilled water to define a resulting gel;
mixing the resulting gel with metal borohydride and metallic particles to define the sodium borohydride-metal-water mixture; and
heating the sodium borohydride-metal-water mixture to produce hydrogen from the sodium borohydride and the water by combustion.

15. The method of claim 14 wherein the first mixture comprises about 2 percent weight sodium hydroxide and about 3 percent weight polyacrylamide.

16. The method of claim 14 wherein the metallic particles of the resulting mixture comprise at least one of aluminum, magnesium, aluminum-magnesium alloy.

17. The method of claim 14 wherein the step of heating includes reactions as follows:
NaBH₄+2 H₂O→NaBO₂+4 H₂; and
Mg+H₂O→MgO+H₂.

18. The method of claim 14 wherein the step of heating comprises reactions as follows:
NaBH₄+2 H₂O→NaBO₂+4 H₂; and
Al+3/2 H₂O→1/2 Al₂O₃+3/2 H₂.

19. The method of claim 14 wherein the step of heating comprises igniting the sodium borohydride-metal-water mixture to produce between about 4 and 7 weight percent hydrogen.

20. The method of claim 14 wherein the sodium borohydride-metal-water mixture has a molecular ratio of the metallic particles and sodium borohydride of between about 1:1 and 2:1.

21. A method of generating hydrogen, the method comprising:
mixing a reactant gel with a metallic powder and metal borohydride to define a resulting mixture, the reactant gel including a stabilizer and a gelling agent in water; and
igniting the resulting mixture to produce hydrogen.

22. A method of generating hydrogen, the method comprising:
preparing a first mixture of a stabilizer in water to define a resulting solution;
mixing the resulting solution with metallic particles and metal borohydride to define a resulting mixture; and
igniting the resulting mixture to obtain hydrogen.

23. The method of claim 22 wherein the first mixture further comprises a gelling agent.

24. The method of claim 23 wherein the stabilizer comprises between about 1 and 10 percent weight sodium hydroxide and the gelling agent comprises between about 1 and 10 percent weight polyacrylamide.

25. The method of claim 23 wherein the stabilizer comprises about 2 percent weight sodium hydroxide and the gelling agent comprises about 3 percent weight polyacrylamide.
